(19) United States
(12) Patent Application Publication
(10) Pub. No.: US 2025/0226900 A1
(43) Pub. Date: Jul. 10, 2025

(54) SIMULATING RADIO FREQUENCY SIGNALS RECEIVED BY A SIMULATED ANTENNA ARRAY ON A SIMULATED PLATFORM

(71) Applicant: BAE SYSTEMS Information and Electronic Systems Integration Inc., Nashua, NH (US)

(72) Inventors: Greg M. Fehling, Nashua, NH (US); Christopher M. Muller, Milford, NH (US); Christopher J. Sherman, Merrimack, NH (US); Frank Alcutt, Milford, NH (US)

(73) Assignee: BAE SYSTEMS Information and Electronic Systems Integration Inc., Nashua, NH (US)

(21) Appl. No.: 18/406,619

(22) Filed: Jan. 8, 2024

(51) Int. Cl. H04B 17/391; H04B 17/00; H04B 17/13

(52) U.S. Cl. CPC H04B 17/3912; H04B 17/0087; H04B 17/13

(57) ABSTRACT

A method to simulate radio frequency (RF) signals generated by one or more simulated antennas of a simulated platform is disclosed. The method includes receiving emitter parameters of a plurality of simulated emitters, the emitter parameters including geolocation of at least one of the simulated emitters. The method further includes receiving navigational parameters of the simulated platform, which are indicative of a simulated navigational path of the simulated platform relative to one or more of the plurality of simulated emitters. The method further includes receiving antenna parameters of a simulated antenna located on the simulated platform. The method further includes generating digital data representative of a RF signal that is estimated to be output by the simulated antenna during simulated traversal of the simulated platform along the navigational path, based on the simulated antenna receiving, in a simulated environment, signals from one or more of the plurality of simulated emitters.

### STATEMENT OF GOVERNMENT INTEREST

This invention was made with United States Government assistance under Contract No. 1033000044. The United States Government has certain rights in this invention.

### FIELD OF DISCLOSURE

The present disclosure relates to a simulation system, and more particularly to simulating radio frequency signals as received by a simulated antenna array on a simulated platform.

### BACKGROUND

It is often necessary to locate and track a target emitter of interest based on signals emitted from that target emitter. Existing systems can perform location and tracking of target emitters with varying degrees of accuracy. These systems employ a detection system including computationally intensive algorithms and complex backend circuits for detecting, direction finding (DF), locating and tracking of the target emitters. Testing such a detection system is non-trivial.

### BRIEF DESCRIPTION OF THE DRAWINGS

FIG. 1 illustrates an emitter geolocation and tracking system comprising a platform, and further illustrates a simulation environment in which a simulation module simulates at least a part of the emitter geolocation and tracking system, in accordance with an embodiment of the present disclosure.

FIG. 2 is a block diagram schematically illustrating selected components of a simulation system, wherein the simulation system comprises (i) a computing device generating digital signals representative of simulated radio frequency (RF) signals output by simulated antennas of a simulated platform, (ii) a waveform generator configured to receive the digital signals and generate corresponding RF signals representing the RF signals output by the simulated antennas, and (iii) a detection system configured to receive the RF signals and estimate location and track the simulated emitters, in accordance with some embodiments of the present disclosure.

FIG. 3A illustrates an example user interface (UI) for inputting emitter parameters associated with simulated emitters, in accordance with some embodiments of the present disclosure.

FIG. 3B illustrates an example UI for inputting platform navigational parameters for a simulated platform, in accordance with some embodiments of the present disclosure.

FIG. 3C illustrates an example UI for inputting receive antenna parameters for a plurality of simulated receive antennas of a simulated platform, in accordance with some embodiments of the present disclosure.

FIG. 4A illustrates example geolocations of simulated emitters, in accordance with some embodiments of the present disclosure.

FIG. 4B illustrates a map display depicting an example navigational path of a simulated platform relative to geolocations of a plurality of simulated emitters, in accordance with some embodiments of the present disclosure.

FIG. 4C illustrates a map display depicting an antenna array geometry of a plurality of simulated receive antennas located on a simulated platform, in accordance with some embodiments of the present disclosure.

FIG. 4C1 illustrates a plot of antenna gain versus azimuth for a specific simulated receive antenna, in accordance with an embodiment of the present disclosure.

FIG. 5A illustrates a plot of slant range to one or more simulated emitters versus time, in accordance with an embodiment of the present disclosure.

FIG. 5B illustrates another plot of receive antenna phase versus time, in accordance with an embodiment of the present disclosure.

FIG. 6A illustrates an example of a waveform generator of a simulation system, in accordance with an embodiment of the present disclosure.

FIG. 6B illustrates an example UI for inputting waveform generator parameters for simulated receive antennas on the simulated platform, in accordance with some embodiments of the present disclosure.

FIGS. 7A and 7B collectively illustrate a flowchart depicting a method of generating digital waveforms that are representative of RF signals generated by simulated receive antennas within a simulation environment, in accordance with an embodiment of the present disclosure.

FIG. 8 illustrates a flowchart depicting a method of generating RF signals that are representative of RF signals generated by simulated receive antennas within a simulation environment, in accordance with an embodiment of the present disclosure.

FIG. 9 illustrates a flowchart depicting a method of estimating and tracking locations of one or more simulated emitters, in accordance with an embodiment of the present disclosure.

Although the following Detailed Description will proceed with reference being made to illustrative embodiments, many alternatives, modifications, and variations thereof will be apparent to those skilled in the art.

### DETAILED DESCRIPTION

Techniques are described for providing a simulation system that generates RF signals, where the RF signals are representative of outputs of simulated receive antennas on a simulated platform navigating with respect to one or more simulated signal emitters. The platform may be, for example, airborne (e.g., drone or airplane) or ground-based (e.g., vehicle such as hum-vee). Similarly, the emitters may be ground-based or airborne. For instance, in one example scenario, the platform is an airborne platform and the emitters are ground-based, although the techniques described herein can be used in any number of scenarios. In one such example, a first RF signal is representative of an output of a first simulated receive antenna on the simulated platform, based on the first simulated receive antenna receiving signals from one or more of a plurality of simulated signal emitters. Similarly, a second RF signal is representative of an output of a second simulated receive antenna on the simulated platform, based on the second simulated receive antenna receiving signals from one or more of the plurality of simulated signal emitters. The first and second RF signals change with time, as and when the platform is moving (e.g., yawing, pitching, and/or rolling) with respect to the simulated signal emitters. A detection system receives the RF signals generated by the simulation system, and aims to estimate and track the locations of the plurality of simulated signal emitters, as and when the simulated platform navigates with respect to the simulated emitters. The RF signals generated by the simulation system are used to develop, test, and/or debug the detection system. Once the detection system is deemed to be functioning properly, it may be installed into an actual platform or otherwise approved for use in the field.

In one embodiment, a method to simulate RF signals generated by one or more simulated antennas of a simulated platform is disclosed. The method comprises receiving emitter parameters of a plurality of simulated emitters, the emitter parameters including at least geolocations of one or more of the plurality of simulated emitters. The method further comprises receiving navigational parameters of the simulated platform, the navigational parameters indicative of at least a simulated navigational path of the simulated platform relative to one or more of the plurality of simulated emitters. The method further comprises receiving antenna parameters of a simulated antenna located on the simulated platform. The method further comprises generating digital data representative of a RF signal that is estimated to be output by the simulated antenna during simulated traversal of the simulated platform along the navigational path, based on the simulated antenna receiving, in a simulated environment, signals from one or more of the plurality of simulated emitters. In an example, a waveform generator receives the digital data representative of the RF signal, and generates the RF signal that is estimated to be output by the simulated antenna. In an example, at least some of the disclosed techniques can be implemented in a computing system or a software product executable or otherwise controllable by such systems, although other embodiments will be apparent (e.g., gate-level logic). Numerous embodiments and applications will be apparent in light of this disclosure.

### General Overview

As mentioned herein above, testing and debugging a detection system for locating and tracking emitters emitting signals of interest is non-trivial. In particular, testing generally involves the actual deployment of the detection system on a given platform and conducting a live test or troubleshooting regime. For instance, the detection system may be deployed on an airborne platform that is then subjected to illumination by a number of known ground-based emitters. Such a deployment-based testing may be expensive and time-consuming or otherwise limited, as it may involve many different flights and changes in emitter geometry to sufficiently assess the detection system. Some software based simulation systems simulate a platform navigating with respect to one or more simulated signal emitters. One such software based simulation system provides a purely software solution, and does not output RF signals representative of simulated output of on board receive antennas. Such a software based simulation system prohibits testing and/or debugging of onboard RF signal processing circuits that are to receive the RF signals from the onboard receive antennas and estimate emitter locations. Other simulation systems are constrained to a predetermined and static set of flight path scenarios of the platform with respect to a simulated emitter. For example, the simulated platform navigates a circular flight path, which is centered about an emitter. In this example, the Angle-of-Arrival does not change over time (e.g., 90 deg if clockwise orbit, or 270 deg if counter-clockwise), and thus the phases of the signals at the outputs of the receive antennas also do not change (static wavefront). Such simulation systems leave all other unspecified flight scenarios untested, which may represent numerous potential vulnerabilities to the system under test. Yet other simulation systems may output RF signals representative of an output of a receiver antenna. However, in such a simulation system, each channel of a waveform generator mimics an individual RF signal received by an onboard antenna from a single emitter. Accordingly, if multiple emitters are to be simulated, for each receive antenna onboard the platform under test and for each emitter, a dedicated channel for each individual signal to be generated has to be used, which increases complexity, cost, size, weight, and/or power of the waveform generator.

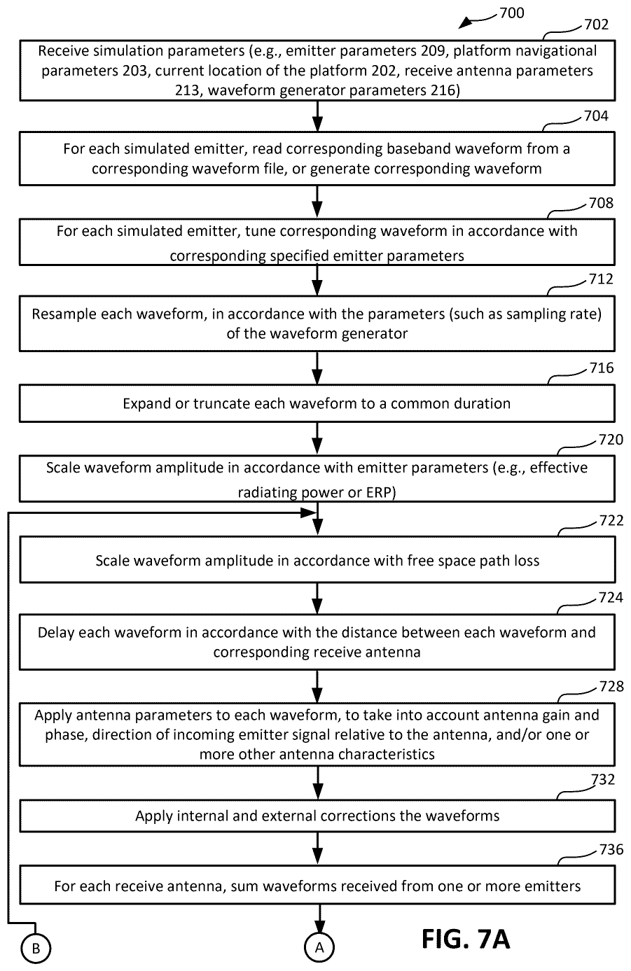

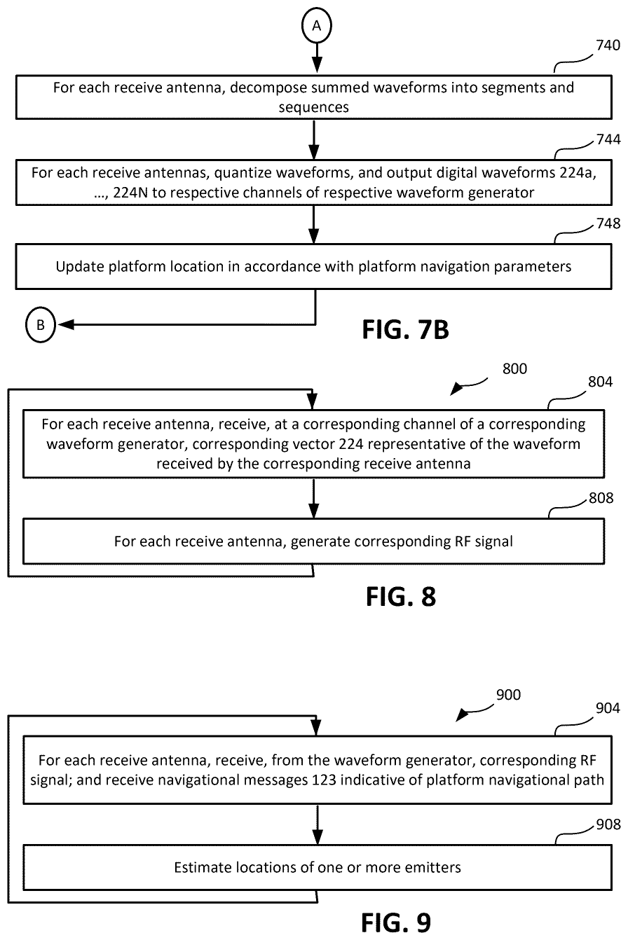

Accordingly, techniques are described herein to provide a simulation system that generates RF signals, where the RF signals are representative of outputs of simulated receive antennas on a simulated platform that is navigating with respect to one or more simulated signal emitters. In an example, the RF signals are used to test and/or debug onboard RF signal processing circuits that are to receive the RF signals from the onboard receive antennas and estimate emitter locations. The navigational path of the simulated platform is highly configurable, and hence, many different and realistic flight paths of the platform can be simulated. For example, platform navigational parameters may be input by a user, where the platform navigational parameters specify a simulated navigational path of the simulated platform. In some example scenarios, the simulated platform is an airborne platform that can move (e.g., yaw, pitch, and/or roll) along any configurable flight path, relative to a number of ground based emitters emitting signals of interest. The techniques described herein may be applied to other scenarios as well. Furthermore, in the simulation system, simulated signals from multiple emitters received by any specific onboard simulated receive antenna are summed in the digital domain (e.g., see process 736 of FIG. 7A), and the summed signal is converted to a corresponding RF signal by a corresponding channel of a waveform generator (e.g., see process 804 of FIG. 8). Accordingly, a single channel of a waveform generator can mimic an RF signal that might be received by an onboard antenna from a plurality of emitters.

Each simulated antenna can receive signals from one or more simulated emitters. For example, during the simulation, a first waveform received at a simulated antenna from a first simulated emitter and a second waveform received at the simulated antenna from a second simulated emitter are estimated. Because the simulated antenna will receive a combination of at least the first and second waveforms, the first and second waveforms are combined (e.g., summed), to represent an effective signal received by the simulated antenna. The combined waveform (which is in digital form) is then passed to a channel of a waveform generator, which generates a corresponding RF signal. Thus, a single channel of the waveform generator can generate a complex RF signal that might be output by a simulated antenna, based on receiving signals from multiple (such as at least the first and second) simulated emitters. Thus, a multi-emitter/single receive antenna scenario can be simulated using a single channel of the waveform generator. This results in reduced cost and complexity of the simulation system.

In an example, the simulation system may also be used to simulate wavefront(s). For example, the simulation system defines multiple receive antennas (e.g., located at known locations on the platform), and includes a dedicated waveform generator channel for each receive antenna. In this use case, the phase of each received signal may be periodically adjusted in accordance with the location of the respective emitter, relative to the location of the respective receive antenna. In some examples, the phase is unique to each emitter-antenna-navigation (e.g., time) permutation, and so a unique set of phases (also known as a steering vector, having dimensions 1×number of antennas) may be applied for each simulated emitter, for each navigation point. Thus, the phase adjustments (steering vector) are applied prior to summing the signals for a given receive antenna that is simulated by a given waveform generator channel.

In an example, a user can specify emitter parameters, through which a user can configure a number and/or locations of the emitters, emitter effective radiated power (ERP) and transmission frequency, and/or a waveform transmitted by an emitter. In an example, a user can specify receive antenna parameters, through which a user can configure a number, locations, and/or directional orientations of the receive antennas on the platform, and/or gain and phase information of the receive antennas. In an example, a user can specify a mapping between the receive antennas and the channels of one or more waveform generators. In case multiple waveform generators are being used, a synchronization module is used to synchronize operations of various channels of the various waveform generators.

During generation of the waveforms, the waveforms emitted by individual emitters are tuned in accordance with corresponding emitter parameters (such as emitter gain and frequency). Individual waveforms may be expanded or truncated, e.g., such that the waveforms from various emitters have the same durations (e.g., such that they can be combined at the receive antenna). The waveforms are also scaled in amplitude and delayed, e.g., to account for free space path loss and distance between an emitter and a receive antenna pair. Also, subsequent to combining (e.g., summing) all waveforms received by a given antenna, the waveform (which is still in digital form) is processed by a corresponding channel of a waveform generator, to generate corresponding analog RF waveform representative of an RF output of the given antenna. The detection system receives RF waveforms corresponding to the various antennas on the platform, and aims to estimate the locations of the emitters. The RF waveforms may also be used to develop, test, and/or debug the detection system, in an example.

The phrase “substantially” has been used throughout this disclosure. In an example, length A is substantially equal to length B implies that A and B are within 5% or within 3% or within 2% or within 1% of each other. In an example, angle P is substantially equal to angle Q implies that P and Q are within 5 degrees, or 3 degrees, or 2 degrees, or 1 degree of each other. A first line (or a first side of a feature) being substantially parallel to a second line (or a second side of a feature) implies that an angle between the two lines (or two sides) is at most 5 degrees, or at most 4 degrees, or at most 3 degrees, or at most 2 degrees, or at most 1 degree, for example. A first feature is substantially symmetrical to a second feature implies that various dimensions of the first feature and corresponding dimensions of the second feature are substantially the same (e.g., within 5% or within 3% or within 2% or within 1% of each other), and locations of the two features with respect to a plane of symmetry (such as a plane of symmetry 212 discussed herein below) are substantially the same (e.g., within 5% or within 3% or within 2% or within 1% of each other).

It should be readily understood that the meaning of “above” and “over” in the present disclosure should be interpreted in the broadest manner such that “above” and “over” not only mean “directly on” something but also include the meaning of over something with an intermediate feature or a layer therebetween. As will be appreciated, the use of terms like “above” “below” “beneath” “upper” “lower” “top” and “bottom” are used to facilitate discussion and are not intended to implicate a rigid structure or fixed orientation; rather such terms merely indicate spatial relationships when the structure is in a given orientation.

### Architecture

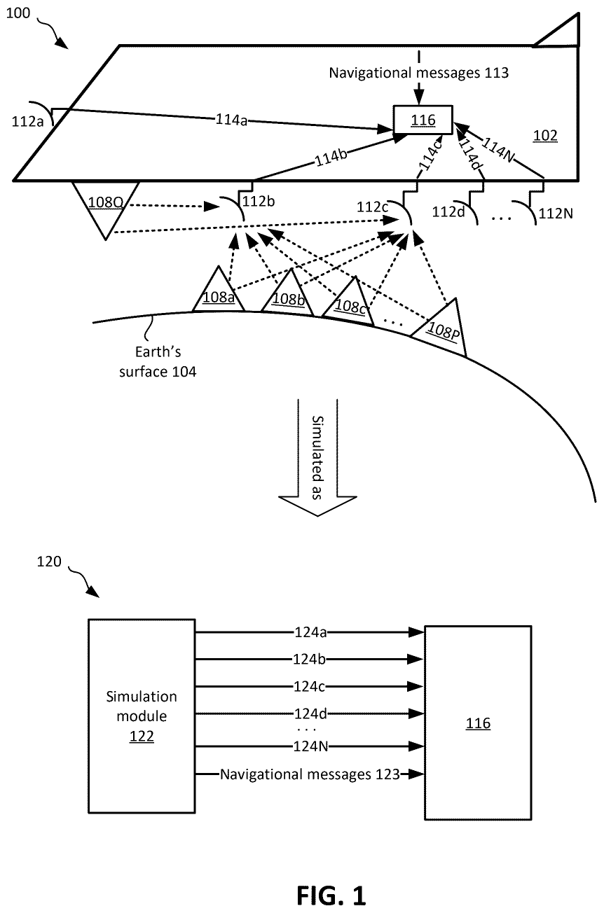

FIG. 1 illustrates an emitter geolocation and tracking system 100 comprising a platform 102, and further illustrates a simulation environment 120 in which a simulation module 122 simulates at least a part of the emitter geolocation and tracking system 100, in accordance with an embodiment of the present disclosure.

In some embodiments, the platform 102 may be a manned-aircraft (e.g., fixed wing or helicopter), an unmanned aerial vehicle (UAV) or drone, a projectile or missile, or any other airborne platform. In some other embodiments, the platform may be ground-based vehicle. In any such cases, the platform 102 is configured to perform geolocation and tracking of one or more emitters of interest 108a, . . . , 108P, where P is a positive integer. In an example, one or more emitters may also be affixed to the platform 102, such as an emitter 108Q. Emitters 108a, . . . , 108P, 108Q (generally referred to herein as emitter 108 in singular, or emitters 108 in plural) are illustrated using triangles, although the emitters 108 may have any appropriate shapes and form factors and configurations.

Each of the emitters 108a, . . . , 108Q emits radio frequency (RF) signals, such as RADAR (Radio Detection and Ranging) signals or communications signals, that can be detected by the platform 102. The emitters 108a, . . . , 108Q may be any appropriate devices emitting RF, such as RADAR transmitters or any wireless communication device (such as a hand-held radio, vehicle-mounted radio, or telecommunications tower). In some embodiments, individual ones of the emitters 108 can be stationary, moving at a constant velocity, or accelerating or decelerating.

In one embodiment, the platform 102 includes a plurality of receive antennas 112a, . . . 112N, where N is an appropriate positive integer. Individual antennas 112 receive signals emitted by one or more emitters 108, such as multiple emitters in the vicinity of the platform 102. For example, FIG. 1 illustrates two example antennas 112b and 112c each receiving signals from the emitters 108a, . . . , 108Q. A phase and/or an amplitude of a signal received by a specific antenna 112 from a specific emitter 108 may be based on a position of the emitter 108 relative to the specific antenna 112, a speed of the platform 102 relative to the emitter 108, a position of the antenna 112 within the platform 102, a gain of the antenna 112 in a direction in which the emitter 108 is located, and/or a type, amplitude, and/or phase of signals emitted by the emitter, for example.

Each antenna 112 outputs corresponding RF signals 114, based on the antenna receiving the RF signals emitted by one or more of the emitters 108a, . . . , 108Q. The platform 102 comprises a detection system 116 configured to receive RF signals 114a, . . . , 114N from the antennas 112a, . . . , 112N, respectively. For example, antenna 112a outputs an RF signal 114a to the detection system 116, where the RF signal 114a is a combination of RF signals received by the antenna 112a from one or more of the emitters 108a, . . . , 108Q. Similarly, antenna 112b outputs an RF signal 114b to the detection system 116, where the RF signal 114b is a combination of RF signals received by the antenna 112b from one or more of the emitters 108a, . . . , 108Q. Similarly, the antennas 112c, . . . , 112N output RF signals 114c, . . . , 114N to the detection system 116.

The detection system 116 receives the RF signals 114a, . . . , 114N from the antennas 112a, . . . , 112N, and aims to estimate and track geolocations of one or more of the emitters 108a, . . . , 108P.

In an example, the detection system 116 receives navigational messages 113 from one or more navigational components of the platform 102, where the navigational messages 113 indicate a position, a velocity, navigational path, and/or other navigational data of the platform 102. The detection system 116 aims to estimate and track locations of one or more of the emitters 108a, . . . , 108P, based on the RF signals 114a, . . . , 114N from the antennas 112a, . . . , 112N and the navigational messages 113.

FIG. 1 also illustrates the simulation system 120 in which the simulation module 122 (also referred to herein as module 122) simulates at least a part of the emitter geolocation and tracking system 100. For example, the module 122 outputs RF signals 124a, . . . , 124N, which are simulated versions of RF signals 114a, . . . , 114N output by the antennas 112a, . . . , 112N. For example, the RF signal 124a output by the simulation system 120 is a simulated and estimated version of the RF signal 114a that could have been output by the antenna 112a, the RF signal 124b output by the simulation system 120 is a simulated and estimated version of the RF signal 114b that could have been output by the antenna 112b, and so on.

The simulation module 122 also outputs navigational messages 123, which provides navigational data (e.g., time, position, velocity) associated with a simulated version of the platform 102. Thus, the navigational messages 123 are simulated version of the navigational messages 113, for example.

The detection system 116 receives the simulated RF signals 124a, . . . , 124N output by the simulated versions of the antennas 112a, . . . , 112N, respectively, and also receives the navigational messages 123. Thus, in the system 100, the detection system 116 receives the actual RF signals 114a, . . . , 114N output by the antennas 112a, . . . , 112N. In contrast, in the system 120, the detection system 116 receives the simulated RF signals 124a, . . . , 124N output by simulated versions of the antennas 112a, . . . , 112N, where the simulated RF signals 124a, . . . , 124N are estimated versions of the actual RF signals 114a, . . . , 114N. The detection system 116 can perform detection tasks (e.g., locate and track emitters), based on the simulated RF signals 124a, . . . , 124N. For example, the simulated RF signals 124a, . . . , 124N can be used to test, calibrate, and/or debug the detection system 116.

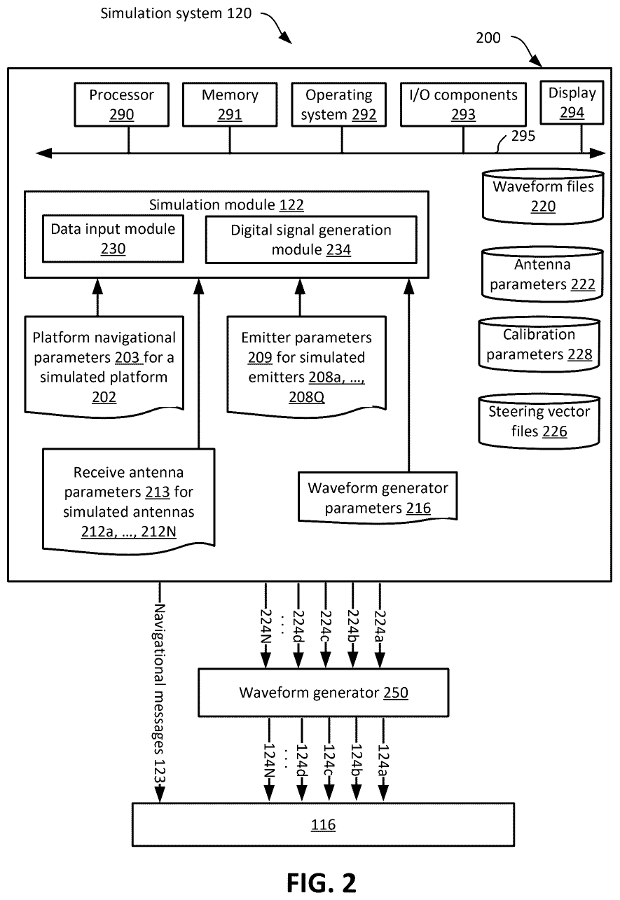

FIG. 2 is a block diagram schematically illustrating selected components of the simulation system 120 of FIG. 1, wherein the simulation system 120 comprises (i) a computing device 200 generating digital signals 224a, . . . , 224N representative of simulated RF signals output by simulated antennas 212a, . . . , 212N of a simulated platform 202, (ii) a waveform generator 250 configured to receive the digital signals 224a, . . . , 224N and generate corresponding RF signals 124a, . . . , 124N representing the RF signals output by the simulated antennas 212a, . . . , 212N, and (iii) the detection system 116 configured to receive the RF signals 124a, . . . , 124N and estimate location and track the simulated emitters, in accordance with some embodiments of the present disclosure.

As can be seen, the device 120 includes the simulation module 122 for implementing the simulation environment, in which a simulated platform 202 files in accordance with navigational parameters 203 over and adjacent to (or relative to) one or more of simulated emitters 208a, . . . , 208Q. The simulated platform 202 has a plurality of simulated antennas 212a, . . . , 212N. The RF signals 124a, . . . , 124N are RF signals estimated to be output by the simulated antennas 212a, . . . 212N.

As will be appreciated, the configuration of the device 200 may vary from one embodiment to the next. To this end, the discussion herein may focus more on aspects of the device 200 that are related to simulating the RF signals output by the simulated antennas 212a, . . . , 212N, and less so on standard componentry and functionality typical of computing devices.

In one embodiment, the device 100 may include any appropriate computing device, such as a laptop computer, a desktop computer, a workstation, an enterprise class server computer, a handheld computer, a tablet computer, a smartphone, a set-top box, a game controller, and/or any other computing device that can provide the simulated environment described herein.

In the illustrated embodiment, the device 200 includes one or more software modules configured to implement the simulation functionalities described herein, as well as hardware configured to enable such implementation. These hardware and software components may include, among other things, a processor 290, memory 291, an operating system 292, input/output (I/O) components 293, a display 294, and the simulation module 122. Digital databases 220, 222, 228, 226 (e.g., that comprises a non-transitory computer memory) stores data, as will be described below.

A bus and/or interconnect 295 is also provided to allow for inter- and intra-device communications. In some embodiments, the device 200 includes the display 294, although in some other embodiments the display 294 can be external to and communicatively coupled to the device 200. Note that in an example, components like the operating system 292 and the simulation module 122 can be software modules that are stored in memory 291 and executable by the processor 290. In an example, at least sections of the simulation module 122 can be implemented at least in part by hardware, such as by Application-Specific Integrated Circuit (ASIC) or microcontroller with one or more embedded routines. The bus and/or interconnect 295 is symbolic of all standard and proprietary technologies that allow interaction of the various functional components shown within the device 200, whether that interaction actually take place over a physical bus structure or via software calls, request/response constructs, or any other such inter and intra component interface technologies, as will be appreciated.

Processor 290 can be implemented using any suitable processor, and may include one or more coprocessors or controllers, such as an audio processor or a graphics processing unit, to assist in processing operations of the device 200. Likewise, memory 292 can be implemented using any suitable type of digital storage, such as one or more of a disk drive, solid state drive, a universal serial bus (USB) drive, flash memory, random access memory (RAM), or any suitable combination of the foregoing. Operating system 292 may comprise any suitable operating system, such as Google Android, Microsoft Windows, or Apple OS X. As will be appreciated in light of this disclosure, the techniques provided herein can be implemented without regard to the particular operating system provided in conjunction with device 200, and therefore may also be implemented using any suitable existing or subsequently-developed platform.

The device 200 also include one or more I/O components 293, such as one or more of a tactile keyboard, a mouse, a touch sensitive or a touch-screen display (e.g., the display 294), a trackpad, a microphone, a camera, scanner, and location services. In general, other standard componentry and functionality not reflected in the schematic block diagram of FIG. 2 will be readily apparent, and it will be further appreciated that the present disclosure is not intended to be limited to any specific hardware configuration. Thus, other configurations and subcomponents can be used in other embodiments.

Also illustrated in FIG. 2 is the simulation module 122 implemented on the device 200. In an example embodiment, the simulation module 122 includes a data input module 230 and a digital signal generation module 234, each of which will be discussed in detail in turn. In an example, the components of the simulation module 122 are in communication with one another or other components of the device 200 using the bus and/or interconnect 295. Although the modules of the simulation module 122 are shown separately in FIG. 2, any of the sub-modules may be combined into fewer modules, such as into a single module, or divided into more modules as may serve a particular implementation.

In an example, the modules 230, 234 of the simulation module 122 performing the functions described herein may be implemented as part of a stand-alone application, as a module of an application, as a plug-in for applications, as a library function or functions that may be called by other applications, and/or as a cloud-computing model. Thus, the components of the simulation module 122 may be implemented as part of a stand-alone application on a personal computing device or a mobile device. Alternatively, or additionally, the simulation module 122 may be implemented in any application that allows implementing the simulation environment described herein.

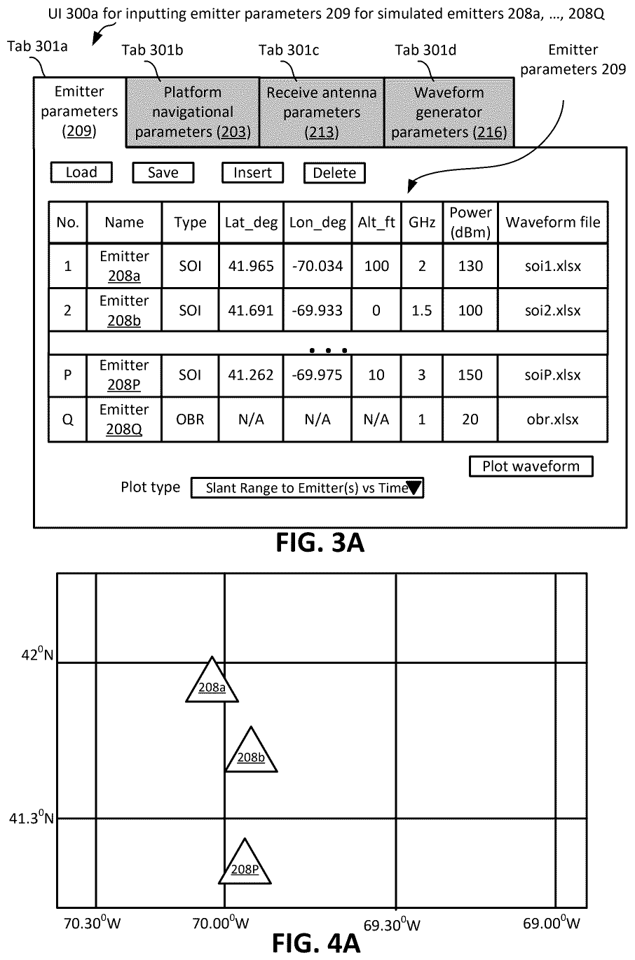

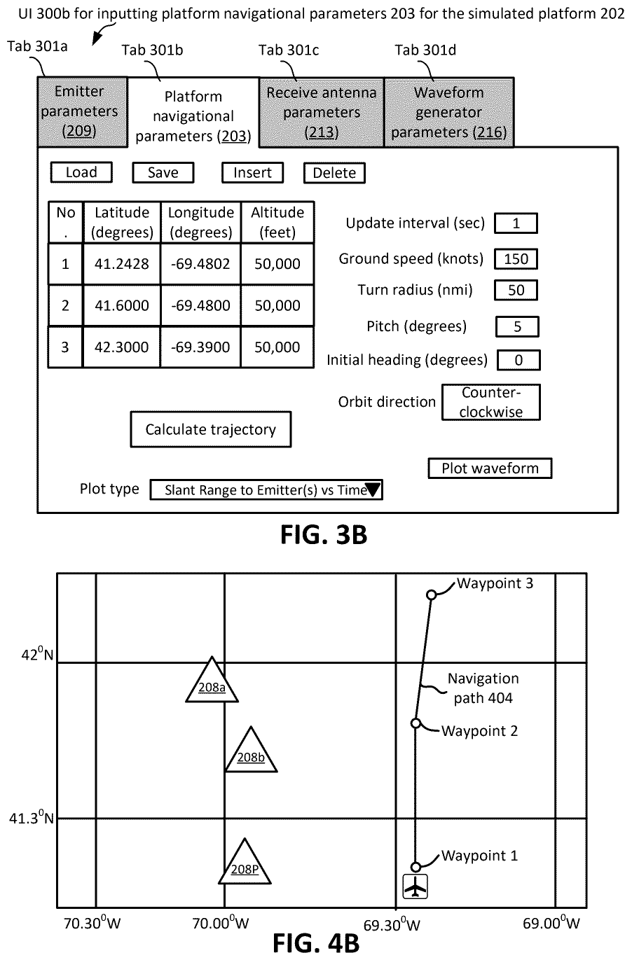

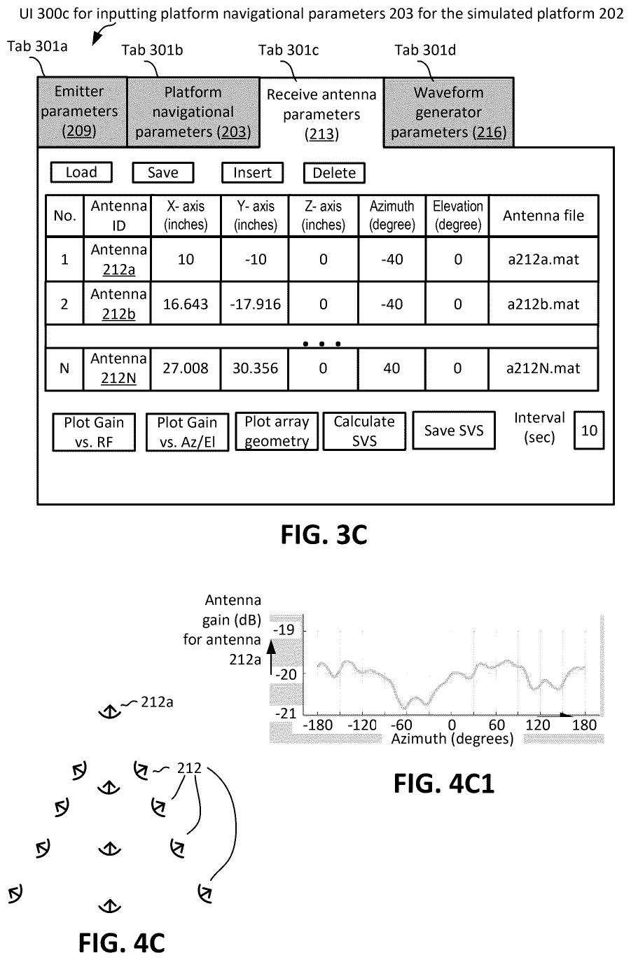

FIG. 3A illustrates an example user interface (UI) 300a for inputting emitter parameters 209 for simulated emitters 208a, . . . , 208Q, in accordance with some embodiments of the present disclosure. For example, the data input module 230 may cause the UI 300a to be displayed on the display 294 of the device 200, and a user can input emitter parameters 209 through the UI 300a. Although in one example the emitter parameters 209 are input through the UI 300a, in another example, the emitter parameters 209 may be input to the simulation module 122 through another manner, such as by uploading a data file including the emitter parameters 209.

The UI 300a has multiple tabs, such as tab 301a for inputting emitter parameters 209, tab 301b for inputting platform navigational parameters 203, tab 301c for inputting receive antenna parameters 213, and tab 301d for inputting waveform generator parameters 216. In the UI 300a, the tab 301a for inputting emitter parameters 209 is active, based on a user selecting this tab. The layout and/or the components of the various tabs 301a, . . . , 301d, as illustrated and described herein, are mere examples, and are implementation specific.

The tab 301a has a tabular format, in which the user can input emitter parameters 209. Some example columns of the tab 301a, as illustrated in FIG. 3A, includes emitter serial number, and name or an identification of the emitters. For example, Q number of emitters are input in the example tab 301a, corresponding to the emitter geolocation and tracking system 100 of FIG. 1. The name or identification of the emitters to be simulated are 208a, 208b, . . . , 208P, 208Q, although the emitters can be named or identified in another manner.

The tab 301a also includes a type of each emitter. In FIG. 3A, a type “SOI” of an emitter indicates an emitter emitting a signal of interest, and a type “OBR” of an emitter indicates an on-board radiator (e.g., an onboard emitter). Thus, emitters 208a, . . . , 208P, which are to be located and tracked by the detection system 116, are emitters transmitting signals of interest and are of type SOI. The emitter 208Q is an on-board emitter, e.g., located on the simulated platform 202. In one example, the detection system 116 would already know about the on-board emitter 208Q (type OBR), including its location, and need not track this emitter. In another example, the detection system 116 may not know about the OBR(s), and the OBR signals may interfere with the SOI(s) signals. The simulation system allows to characterize how the system under test (e.g., the detection system 116) performs against SOI(s) signals, in the presence of OBR(s) signals. Unlike SOI signals, whose amplitudes and phases change over time (depending on distance and/or angle relative to the platform), the OBR signals received by the antennas have substantially constant amplitude and phase (e.g., as the location of the OBR signal doesn't change with respect to the receive antenna locations).

The tab 301a also includes latitude and longitude (e.g., in degrees) and altitude (e.g., in feet or other appropriate unit of altitude) of each emitter having the type SOT. Note that the on-board emitter 208Q is moving with navigation of the simulated platform 202, and hence, it's location would change with that of the platform 202. Hence, the location of the on-board emitter 208Q is not provided. The simulated SOI emitters can be virtually located at an appropriate altitude (e.g., Z axis height from sea level), as illustrated in FIG. 3A. Note that although FIG. 3A doesn't illustrate a scenario in which an emitter is mobile (e.g., an emitter on a moving vehicle), the tab 301a can be modified to include mobile emitters as well.

The tab 301a also includes a transmitting radio frequency (GHz) and a power (e.g., in decibel milliwatts or dBm) of individual emitters. Note that the RF frequencies of the various emitters need not be same or similar, although RF frequencies of two or more emitters can be the same in an example. In an example, the RF frequencies of the two or more emitters may differ by any intended amount (e.g., as long as the waveform generator 250 of the simulation system 120 can generate the RF frequencies of each of the emitters). For example, a frequency of a signal emitted by one emitter can differ from a frequency of a signal emitted by another emitter by at least 500 MHz, or 1 GHz, or 2 GHz, as illustrated in FIG. 3A.

In one embodiment, the tab 301a also has an option to upload waveform files for each emitter. For example, a waveform file soil.xlsx corresponding to the SOI emitter 208a may be an excel (or another database) file that includes the waveform (e.g., baseband samples, and/or parameters that describe the baseband waveform) transmitted by the emitter 208a. For example, if an emitter is a RADAR system, the corresponding waveform file may include parameters that describe the transmitted RADAR pulses (e.g., pulse width, modulation type, repetition interval). In an example, during simulation, the simulation module 122 may repeat the waveform file in a loop. For example, a waveform file may include data corresponding to a few milliseconds, or few seconds, or few minutes. During simulation, the simulation module 122 may repeat the waveform file in a loop, such that emitter transmission for a longer duration may be achieved.

Note that during simulation, the baseband data samples may be transmitted at any given frequency (e.g., so long as said frequency is supported by the waveform generator). For example, data included within the waveform file soil.xlsx may be modulated and transmitted at a radio frequency, such as 1 GHz, or 2 GHz, or another appropriate frequency. For the example of FIG. 3A, the data included within the waveform file soil.xlsx of the emitter 208a may be transmitted at 2 GHz, as this is the frequency specified for the emitter 208a.

Thus, during simulation, the emitters 208a, . . . , 208Q are operated in accordance with the emitter parameters 209. In an example, the locations (latitude, longitude, and/or altitude) of the emitters form ground truth locations, and the simulation environment (e.g., the detection system 116) aims to estimate and track the ground truth locations of the emitters.

FIG. 4A illustrates example geolocations of the simulated emitters 208a, . . . , 208Q, in accordance with some embodiments of the present disclosure. The geolocations correspond to the latitude and longitude of the emitter parameters 209 of the simulated emitters 208a, . . . , 208P, as entered through the UI 300a of FIG. 3. In an example, once the emitter parameters 209 have been entered via the UI 300a, the emitter location(s) may appear on a map display, such as that illustrated in FIG. 4A.

In one embodiment, a user can optionally plot the waveform associated with individual emitter (e.g., using the “plot waveform” option in the UI 300a of FIG. 3A). For example, the user may select one of a plurality of plot options (in FIG. 3A, an option to plot “Slant Range to Emitter(s) versus Time” plot selected). The plots will be described below. Example plots may contain multiple axes, e.g., depicting one or more of amplitude versus time, phase versus time, spectrogram, and power spectral density plots.

FIG. 3B illustrates an example UI 300b for inputting platform navigational parameters 203 for the simulated platform 202, in accordance with some embodiments of the present disclosure. For example, the data input module 230 may cause the UI 300b to be displayed on the display 294 of the device 200, and a user can input platform navigational parameters 203 for the simulated platform 202 through the UI 300b.

As described above, the platform navigational parameters 203 for the simulated platform 202 are input through the tab 301b. The tab 301b allows the user to enter waypoints, e.g., geolocations through which the simulated platform 202 is to navigate. For example, three example waypoints, including their latitude, longitude, and altitude, are entered in the UI 300b.

Also illustrated are prompts to enter an update interval, a ground speed of the platform 202, a turn radius of the platform 202, and/or a pitch and initial heading of the platform 202. Based on these parameters and the waypoints, the simulation module 122 (such as the data input module 230) generates a navigational path for the simulation of the platform 202. Although a single ground speed of the platform 202 can be entered in the UI 300b, the UI 300b can be appropriately modified, such that variable ground speed may also be entered.

FIG. 4B illustrates a map display depicting an example navigational path 404 of the simulated platform 202 and geolocations of the simulated emitters 208a, . . . , 208Q, in accordance with some embodiments of the present disclosure. The three waypoints of FIG. 3B are illustrated in FIG. 4B. The simulation module 122 estimates the route between the waypoints, e.g., based on the waypoints and the parameters input through the UI 300b.

The generated trajectory or navigational path may include platform position, velocity, and Euler angles at each update interval. In an example, the simulation module 122 iteratively calculates the trajectory and/or other relevant states used in trajectory calculation using, for example, Euler and Adams-Bashforth methods over the scenario duration. The calculated trajectory is displayed on the map display of FIG. 4B.

FIG. 3C illustrates an example UI 300c for inputting receive antenna parameters 213 for simulated receive antennas 212a, . . . , 212N on the simulated platform 202, in accordance with some embodiments of the present disclosure. For example, the data input module 230 may cause the UI 300c to be displayed on the display 294 of the device 200, and a user can input receive antenna parameters 213 for the simulated platform 202 through the UI 300c.

As described above, the receive antenna parameters 213 for the simulated platform 202 are input through the tab 301c. The tab 301c allows the user to enter locations and one or more other parameters of the simulated receive antennas 212a, . . . , 212N that are on the simulated platform 202. For example, a reference point within the platform is predefined, and locations of each receive antenna with respect to the reference point is input through the UI 300c. For example, referring to FIG. 3C, the receive antenna 212a is at a distance of 10 inches from the reference point along the X-axis direction, at a distance of −10 inches from the reference point along the Y-axis direction, and at a distance of 0 inches from the reference point along the Z-axis direction.

Also illustrated are orientation of each receive antenna 212, e.g., a direction at which a receive antenna boresight is pointing. For example, gain of a receive antenna for signals received from a specific direction is based on such an orientation of the receive antenna. As illustrated in FIG. 3C, the orientation of the receive antenna 212 are represented using azimuth and elevation angles of the receive antenna 212.

In one embodiment, a user can input antenna patterns or antenna files for individual receive antennas 212. An antenna file associated with a receive antenna 212 describes characteristics of the receive antenna 212. For example, the antenna file associated with the receive antenna 212 includes gain and phase of the antenna as a function of frequency of receive signals, direction or angle (e.g., azimuth and elevation) from which the signals are received, and/or other appropriate parameters associated with the antennas. In the example of FIG. 3C, the antenna files may be in the format of .mat (such as Matlab® files), although other formats for the antenna files may also be used.

FIG. 4C illustrates a map display depicting an antenna array geometry of the simulated receive antennas 212a, . . . , 212N located on the simulated platform 202, in accordance with some embodiments of the present disclosure. For example, the antennas may be deployed on the exterior hull or body of a simulated airborne platform 202, or on the exterior of a ground-based platform 202. Note that the example locations of the receive antennas 212 illustrated in FIG. 4C correlate with the example X, Y, and Z axis coordinates of the receive antennas 212 input in FIG. 3C.

In an example, once the receive antenna parameters 213 have been input through the UI 300c, different plots for different antenna parameters for one or more of the receive antennas 212a, . . . , 212N may be plotted. For example, the UI 300c of FIG. 3C has options to generate various plots. For example, a user can select, for a desired receive antenna (such as antenna 212c, for example), antenna gain versus frequency, and the module 122 generates the corresponding plot. Other example plots include antenna gain versus azimuth, antenna gain versus elevation, and/or other appropriate plots associated with selected one or more antennas. For example, FIG. 4C1 illustrates a plot of antenna gain versus azimuth for a specific simulated receive antenna, in accordance with an embodiment of the present disclosure. The X axis represents azimuth angle (in degrees) and the Y axis represents gain (in dBi). The plot is for a specific antenna having a specific elevation, such as an elevation of 10 degrees. Thus, if the signal were to be received from about negative 60 degrees azimuth and 10 degrees elevation, the realized antenna gain would be approximately −21 dBi, as illustrated in FIG. 4C1.

In an example, the user may also select an option to plot the receive antenna array geometry, illustrated in FIG. 4C, which generates a map or a plot showing the location and boresight of each antenna element in cartesian coordinates.

In another example, the user may select an option to calculate steering vectors (SVs) 226. A steering vector 226 is an N-element complex-valued vector which describes the amplitude and phase of a signal, at each of N receive antennas 212a, . . . , 212N, at a single instant in time. In an example, the module 122 may calculate one steering vector per emitter, per navigation point. In an example, the user has an option of writing the steering vectors and/or associated navigational data to file and provide the file to the module 122 through the UI 300c, e.g., to support stand-alone software testing. In an example, the steering vector units take into account the emitter effective radiated power (ERP), distance and/or free space path loss between the emitter and individual receive antennas, receive antenna effects (e.g., gain, which is dependent on frequency, azimuth, elevation, phase, and antenna location), or other associated parameters.

In an example, the device 200 may transmit the steering vector file 226 to the detection system 116, where the steering vector file 226 may act as a ground truth. For example, the detection system 116 performs the detection and measurement of the emitted signals, and compares the measured steering vectors with the ideal or ground truth steering vector file 226, e.g., to estimate how accurately the detection system 116 was able to estimate angle-of-arrival.

After the platform navigational parameters 203, emitter parameters 209, and receive antenna parameters 213 have been input to the module 122 (such as using the data input module 230 of the module 122), as described above, the user can generate one of a plurality of plots representative of the various parameters that were input. Examples of such plots include platform heading versus time plot, pitch and/or roll of the platform versus time plot, platform altitude versus time plot, ground speed of the platform versus time plot, where such plots depict navigational data of the simulated platform 202 (e.g., how the simulated platform 202 is moving with respect to the ground).

Other types of plots may also be possible. For example, some plots may represent how the azimuth and elevation from the simulated platform 202 to the emitter(s) changes with time. Examples of such plots include azimuth to one or more emitters versus time (e.g., North-East-Down coordinate frame), elevation to one or more emitters versus time (e.g., North-East-Down coordinate frame), azimuth to one or more emitters versus time (e.g., Body Coordinate Frame), elevation to one or more emitters versus time (e.g., Body Coordinate Frame), slant range to one or more emitters versus time, slant range to one or more emitters versus azimuth. Examples of other types of plots include signal propagation loss versus time, power at platform skin versus time, receive antenna gain versus time, receive antenna phase versus time, receive antenna gain versus azimuth, receive antenna phase versus azimuth, and power at receive antenna feed versus time. Other appropriate plots may also be possible.

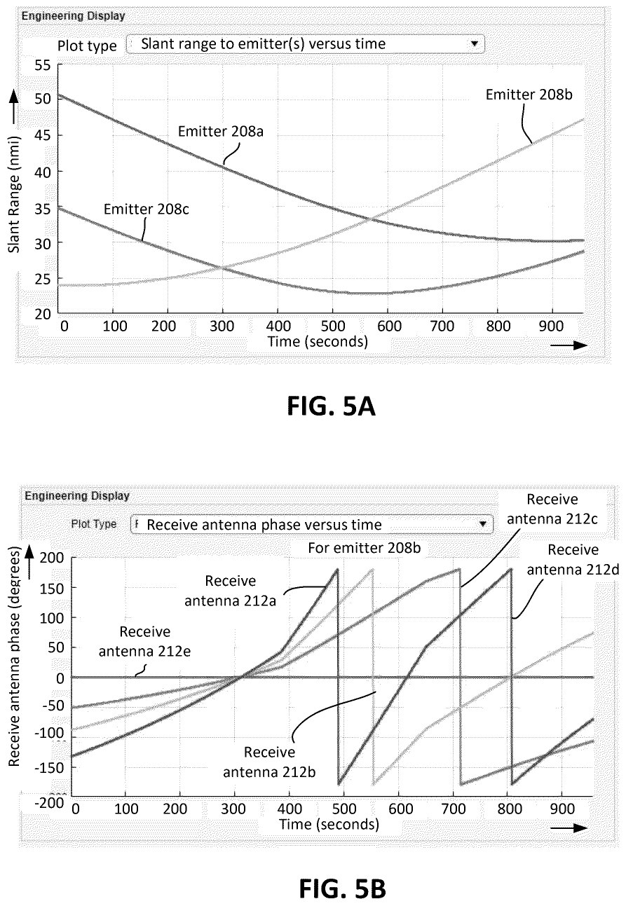

For example, FIG. 5A illustrates a plot of slant range to one or more simulated emitters versus time, in accordance with an embodiment of the present disclosure. Plots for three example emitters 208a, 208b, 208c are illustrated. The Y axis represents slant range in nautical miles, and X axis represents time in seconds.

FIG. 5B illustrates another plot of receive antenna phase versus time, in accordance with an embodiment of the present disclosure. Plots for five example receive antennas 212a, . . . , 212e are illustrated. The Y axis represents phase in degrees, and X axis represents time in seconds. The phase of antenna 212e is normalized to zero, and phases of the other receive antennas 212a, . . . , 212d are illustrate relative to the phase of antenna 212e. Although FIGS. 5A and 5B illustrate two example plots, many different types of plots may be generated, few examples of which has been discussed above.

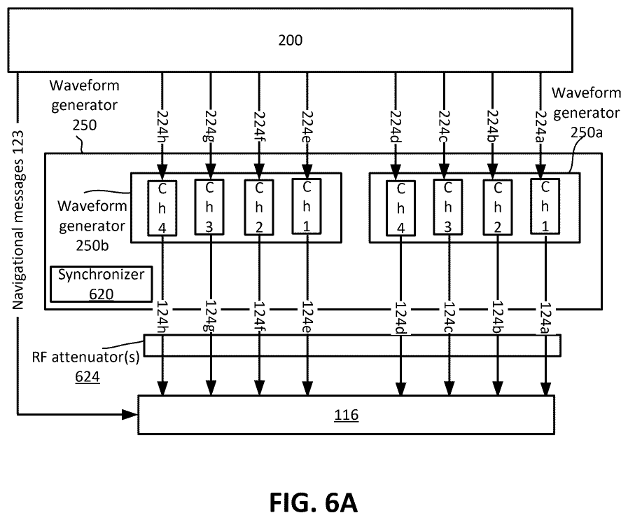

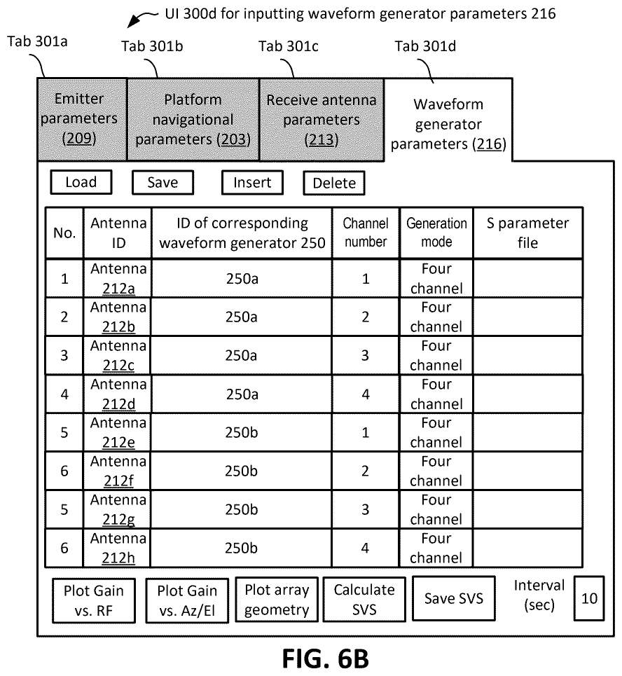

FIG. 6A illustrates an example of the waveform generator 250 of the simulation system 120, in accordance with an embodiment of the present disclosure. For example, as discussed above with respect to FIG. 2, the waveform generator 250 receives the digital signals 224a, . . . , 224N from the device 200, and generates corresponding RF signals 124a, . . . , 124N representing the RF signals output by the simulated antennas 212a, . . . , 212N, respectively. In FIG. 6A, eight RF antennas 212a, . . . , 212h are simulated (the antennas 212a, . . . , 212h are illustrated in FIGS. 2, 3C, and 6B described below), although any different number of antennas may also be simulated. Thus, the waveform generator 250 receives the digital signals 224a, . . . , 224h corresponding to the eight RF antennas 212a, . . . , 212h, respectively, and generates corresponding eight RF signals 124a, . . . , 124h. The RF signal 124a, for example, is an RF signal output by the simulated antenna 212a. Similarly, the RF signal 124b, for example, is an RF signal output by the simulated antenna 212b, and so on. The RF signals 124a, . . . , 124h, collectively, represent the outputs of a receive antenna array, which is located in the far-field of one or more emitters. The phases of said RF signals have been adjusted appropriately so as to model the approaching wavefront.

In one embodiment, the waveform generator 250 may comprise a single waveform generator, or may comprise a group of multiple waveform generators. In the example of FIG. 6A, the waveform generator 250 includes two waveform generators 250a and 250b, although another number (such as one, three, or higher) may also be possible.

In the example of FIG. 6A, the waveform generator 250a processes digital signals 224a, . . . , 224d, and generates corresponding RF signals 124a, . . . , 124d, respectively. Similarly, the waveform generator 250b processes digital signals 224e, . . . , 224h, and generates corresponding RF signals 124h, . . . , 124h, respectively. In an example, the waveform generators 250a, 250b can generate digital signals 124 corresponding to arbitrary digital signals 224, and hence, each of the waveform generators 250a, 250b is also referred to herein as an arbitrary waveform generator (AWG).

In an example, each of the waveform generators 250a, 250b includes one or more channels, where each channel processes a corresponding digital signal 224 to generate a corresponding RF signal 124. For example, waveform generator 250a comprises channels 1, . . . 4, to respectively process digital signals 224a, . . . , 224d and generate RF analog signals 124a, . . . 124d, respectively. Similarly, waveform generator 250b comprises channels 1, . . . , 4, to respectively process digital signals 224e, . . . , 224h and generate RF analog signals 124e, . . . , 124h, respectively. In an example, individual channels 1, 2, 3, and 4 of the waveform generators 250a, 250b comprise a digital to analog converter (DAC), or another appropriate circuit to convert the digital signals 224 to corresponding RF signals 124.

Thus, as discussed above, each of the waveform generators 250a, 250b can have one or more RF outputs, e.g., corresponding to one or more channels. In an example, each channel comprises a DAC, or another appropriate circuit to convert a corresponding digital signal 224 to a corresponding RF signal 124. In an example, the DAC sample clock ranges from 53.76 to 65 Giga-samples/second (GSa/s), although other clock rates are also possible. Such a range of sample clock supports a maximum instantaneous bandwidth (IBW) of about 25.6 GHz in a single-channel mode (e.g., when only one channel is active).

In an example, a waveform generator may operate in a single channel mode, or a multi-channel mode (such as a four channel mode discussed with respect to FIG. 6B). In a single channel mode, a single channel of the waveform generator is operational, resulting in a higher supported clock sample rate. In an example, in order to support and test applications with multiple simultaneous emitters and multiple antennas, a waveform generator may operate in a four-channel mode, which may result in the input waveform to be interpolated by a factor of 4. This interpolation reduces the waveform sample rate by a factor 4, which in turn limits the instantaneous bandwidth, such as limit the instantaneous bandwidth to about 6.4 GHz.

In an example, a maximum output amplitude of RF signals 124a, . . . , 124N is 1 Vpp (e.g., corresponding to about +4 dBm). Output amplitude can be controlled via digital sample value of digital signals 224a, . . . , 224N. In an example, the digital signals 224a, . . . , 224N may be 8 bit signals, e.g., with a DAC resolution of 8 bits, although other DAC resolution may also be possible. In an example, output amplitude of the waveform generators 250a, 250b may also be controlled by real-time finite impulse response (FIR) filter coefficient scaling, and/or analog gain control.

In an example, output phase of the waveform generators 250a, 250b can be controlled via digital sample value, real-time DAC clock delay, and real-time FIR filter coefficient manipulation. Each waveform generator 250a, 250b has up to 16 GSa of waveform memory, e.g., which is 4 GSa (250 msec) per channel. In an example, one or both the waveform generators 250a, 250b have an optional sequencer function, which allows the user to exploit periodic waveforms, thereby achieving efficient use of the finite waveform memory (see process 740 of method 700 herein below).

In one embodiment, the waveform generator 250 also includes a synchronizer circuit 620. The synchronizer circuit 620 synchronizes generation (across the waveform generator modules) of the RF signals 124a, . . . , 124h waveforms. For example, the waveform generator 250a may ensure that the output of the channels 1, 2, 3, 4 of the waveform generator 250a are synchronized within a threshold time value, such as are synchronized within 25 picoseconds, 20 picoseconds, 10 picoseconds, or 5 picoseconds. Similarly, the waveform generator 250b may ensure that the output of the channels 1, 2, 3, 4 of the waveform generator 250b are synchronized within a threshold time value, such as are synchronized within 25 picoseconds, 20 picoseconds, 10 picoseconds, or 5 picoseconds. The synchronizer circuit 620 synchronizes the outputs of the two waveform generators 250a, 250b to be within, for example, 200 picoseconds, 150 picoseconds, 100 picoseconds, 50 picoseconds, or 10 picoseconds.

As illustrated, the RF signals 124a, . . . , 124h may be attenuated by one or more RF attenuators 624 prior to being transmitted to the detection system 116. The attenuators 624 may be, for example, used to achieve signal amplitudes (dBm) that are below the lowest supported output amplitude of the waveform generator. In another example, the RF attenuators 624 may be absent from the system.

In an example, the device 200 communicates with the waveform generators 250a, 250b using an appropriate communication adapter of the device 200 (not illustrated in FIG. 2 or 6A). An appropriate communication protocol may be used for communication between the device 200 and the waveform generators, such as PCIe (Peripheral Component Interconnect Express), USB (Universal Serial Bus), or another appropriate communication protocol.

FIG. 6B illustrates an example UI 300d for inputting waveform generator parameters 216 for simulated receive antennas 212a, . . . , 212N on the simulated platform 202, in accordance with some embodiments of the present disclosure. For example, the data input module 230 may cause the UI 300d to be displayed on the display 294 of the device 200, and a user can input waveform generator parameters 216 of the waveform generators 250a, 250b through the UI 300d.

As described above, one or more waveform generators may be used, such as waveform generators 250a, 250b, where each waveform generator 250a, 250b include one or more channels. The waveform generator parameters 216 map individual receive antennas 212a, . . . , 212N to corresponding channels of corresponding waveform generator. Although only eight antennas 212a, . . . , 212h are illustrated in FIG. 6B, there may be any different number of antennas mapped to corresponding number of channels of corresponding number of waveform generators.

As illustrated in FIG. 6B, for example, antenna 212a is mapped to channel 1 of waveform generator 250a, antenna 212h is mapped to channel 4 of waveform generator 250b, and so on. Thus, for example, channel 1 of the waveform generator 250a outputs RF signal 124a, which is an output of the simulated antenna 212a (also see FIG. 6A). Similarly, channel 4 of the waveform generator 250b outputs RF signal 124h, which is an output of the simulated antenna 212h.

In an example, the waveform generator parameters 216 may also include a waveform generation mode for individual channels of individual waveform generators. For example, all channels in the example of FIG. 6A operate in a four channel mode, in which all four channels of the waveform generator are operational.

FIGS. 7A and 7B, in combination, illustrate a flowchart depicting a method 700 of generating digital waveforms 224a, . . . , 224N that are representative of RF signals generated by simulated receive antennas 212a, . . . , 212N within the simulation environment 120, in accordance with an embodiment of the present disclosure. The method 700 is at least in part performed by the data input module 230 and the digital signal generation module 234 of the simulation module 122 of the simulation system 120 of FIG. 2.

At 702 of the method 700, various simulation parameters are received (e.g., by the data input module 230). Examples of such simulation parameters include emitter parameters 209, platform navigational parameters 203, receive antenna parameters 213, waveform generator parameters 216. For example, a user may enter one or more such simulation parameters through one or more of the UIs 300a, . . . , 300d discussed above. Additionally, or alternatively, one or more of the simulation parameters may be provided via one or more files that include the simulation parameters.

The method 700 then proceeds from 702 to 704. At 704, for each emitter to be simulated, corresponding baseband waveform is read (e.g., by the digital signal generation module 234) from a corresponding waveform file, or the corresponding waveform is generated on-the-fly. Example of a waveform file has been discussed above with respect to FIG. 3A (e.g., waveform file soil.xlsx). For example, a waveform file may include a baseband signal that a corresponding simulated emitter is to transmit during the simulation.

The method 700 then proceeds from 704 to 708. At 708, for each simulated emitter, corresponding waveform is tuned in accordance with corresponding specified emitter parameters. Examples of the emitter parameters include emitted location and/or frequency of transmission by the emitter. For example, at a specific emitter, contents of a corresponding waveform file, which are baseband data, may be transmitted at a specific RF frequency entered through the UI 300a. For example, data included within the waveform file soil.xlsx (see FIG. 3A) may be transmitted at 1 GHz, or 2 GHz, or at another appropriate frequency. For the specific example of FIG. 3A, the data included within the waveform file soil.xlsx may be transmitted at 2 GHz, as this is the frequency specified for the emitter 208a. Thus, if there are Q emitters 208a, . . . , 208Q, waveforms of all such emitters are generated. As discussed above with respect to FIG. 3A, emitters can be of type SOI (signal of interest, locations of which are unknown to the detection system 116) or OBR (on-board emitters, locations of which are known to the detection system 116), and waveforms of both such emitters are generated and tuned.

The method 700 then proceeds from 708 to 712. At 712, each waveform is resampled (e.g., by the digital signal generation module 234), in accordance with the parameters (such as sampling rate) of the waveform generator 250. For example, the waveform generator 250 may sample data at a given sampling rate, and the waveforms may match the sampling rate of the waveform generator 250.

The method 700 then proceeds from 712 to 716. At 716, each waveform is expanded or truncated to a common duration. For example, different emitters may have different waveforms that take different time durations for transmission. However, the waveforms are to be summed at a later process (e.g., as a receive antenna 212 may receive summation of waveforms from multiple emitters within its reception range). Accordingly, for summation, the waveforms transmitted by the different simulated emitters has to have the same duration. Expanding a waveform may include duplication or replication the same waveform (or at least a part of the waveform) one or more times, and/or padding a waveform with zero values at the end. Truncating a waveform may include truncating a beginning portion, an end portion, or any intermediate portion of the waveform.

The method 700 then proceeds from 716 to 720. At 720, each waveform amplitude is scaled in accordance with emitter parameters (e.g., effective radiating power or ERP of a corresponding emitter). For example, an emitter emitting with relatively higher power has a relatively higher ERP, and hence, signals transmitted by the emitter will have a relatively higher power, and vice versa. Subsequent to scaling the waveforms with corresponding emitter parameters, each waveform is representative of how the corresponding emitter would transmit the corresponding waveform.

The method 700 then proceeds from 720 to 722. At 722, each waveform amplitude is scaled in accordance with free space path loss between the corresponding emitter and the corresponding receive antenna. For example, a waveform received by a first antenna from a first emitter would experience a free space path loss that is based at least in part on a distance between the first antenna and the first emitter, and the frequency of transmission. Accordingly, the amplitude scaling accounts for this free space path loss between each emitter and each antenna. For example, this free space path loss changes with navigation of the simulated platform 202 over the simulated emitters. Accordingly, as and when the simulated platform 202 moves with respect to the simulated emitters, the simulation module 122 continually updates the scaling (e.g., process 722 is repeated in a loop).

The method 700 then proceeds from 722 to 724. At 724, each waveform is delayed in accordance with the distance between each emitter and corresponding receive antenna. Thus, each emitter's waveform will get delayed by a corresponding unique amount of time. Note that this delay changes with location of the simulated platform 202 over the simulated emitters. Accordingly, as and when the simulated platform 202 navigates over the simulated emitters, the simulation module 122 continually updates the delay (e.g., process 722 is repeated in a loop).

The method 700 then proceeds from 724 to 728. At 728, antenna parameters are applied to each waveform, to take into account antenna gain and phase, direction of incoming emitter signal relative to the antenna, and/or one or more other antenna characteristics. For example, the antenna parameters 213 may be used. Thus, for a waveform received by an antenna from a specific direction, the antenna gain for waveforms incoming from that direction (e.g., directional antenna gain) would be taken into account in process 728. Also, steering vectors are applied during this process, which effectively rotates the phase of the received signal in accordance with the location of the respective receive antenna within the array, so as to accurately model the approaching wavefront.

Thus, after process 728, each waveform is representative of what a corresponding simulated antenna receives from a simulated emitter. Note that an antenna may receive multiple waveforms from multiple emitters (e.g., the antenna may receive a summation of multiple waveforms from multiple emitters).

The method 700 then proceeds from 728 to 732. At 732, internal and external corrections are applied to each waveform, e.g., to compensate for differences in various channels of the waveform generators 250. For example, during a calibration of the waveform generators 250a, 250b, any gain or attenuation (or phase shift) provided by individual channels of the waveform generators 250a, 250b are estimated, and saved as calibration parameters 228. Subsequently, at process 732, individual waveforms are corrected based on the calibration parameters 228. For example, the waveform generator parameters 216 indicate that antenna 212a is mapped to channel 1 of waveform generator 250a. Accordingly, one or more waveforms received by the antenna 212a (e.g., from one or more corresponding emitters) are corrected in accordance with the calibration parameters 228 for channel 1 of waveform generator 250a.

The method 700 then proceeds from 732 to 736. At 736, for each receive antenna, waveforms received from one or more emitters by the corresponding antenna are summed. Merely as an example, during a current location of the simulated platform 202, the receive antenna 212a may receive waveforms from the emitters 208a, 208b, and 208Q (e.g., other emitters may be too far away from the current location of the platform, and hence, waveforms from those emitters may not reach the antenna 212a). Accordingly, in such a scenario, waveforms from emitters 208a, 208b, 208Q received at the antenna 212a are summed up.

Note that the waveforms received by individual antennas change over the navigational path of the platform. Accordingly, as and when the simulated platform 202 navigates (e.g., moves, yaws, pitches, and/or rolls) over the simulated emitters, the simulation module 122 continually updates the summation of process 736 (e.g., process 736 is repeated in a loop).

The method 700 continues from FIG. 7A to FIG. 7B, and proceeds from 736 to 740. At 740, for each receive antenna, corresponding summed waveforms may optionally be decomposed into segments and sequences. For example, a waveform received by an antenna may be decomposed into S number of segments. If two segments are at least in part identical, the simulation module 122 may replace the later segment with a pointer to the earlier identical segment, which may result in reduced usage of resources (such as memory and/or processing optimization).

The method 700 then proceeds from 740 to 744. At 744, for each receive antennas, the corresponding waveforms are quantized, and quantized digital waveforms 224a, . . . , 224N are output by the summation module 122 to respective channels of respective waveform generator 250a or 250b. For example, during the summation of the process 736, floating point digits are generated for the waveforms. For example, each waveform is a vector of floating point numbers. The floating point numbers may be quantized, prior to transmitting the waveforms to the waveform generators 250a, 250b.

For example, as illustrated in FIG. 6B, antenna 212a is mapped to channel 1 of waveform generator 250a. Accordingly, a digital vector 224a representative of the waveform received by the antenna 212a is transmitted to channel 1 of waveform generator 250a. Similarly, a digital vector 224h representative of the waveform received by the antenna 212h is transmitted to channel 4 of waveform generator 250b, and so on. Operations of the waveform generators 250a, 250b are discussed below with respect to FIG. 8.

The method 700 then proceeds from 744 to 748. At 748, location of the simulated platform 202 is updated in accordance with platform navigational parameters 203. For example, the simulated platform 202 may move from one location to the next within the simulated environment, in accordance with the platform navigational parameters 203. Once the platform 202 moves, the waveforms received by the antennas have to be updated accordingly. For example, with change in distance and/or angle between the emitters and the antennas resulting from a change in location of the platform, the free path loss of process 722, the delay of process 724, and/or one or more processes of the method 700 will also change. Hence, the method 700 loops back from 748 of FIG. 7B to 722 of FIG. 7A.

Note that in one example, the method 700 loops back to process 722. For example, the tuning of waveforms in process 708, the resampling of waveforms in process 712, the expanding or truncating of waveforms in process 716, and/or the scaling of waveforms in process 720 may be independent of a current location of the platform 202. Hence, with change in platform location in 748, the processes 708, . . . , 720 need not be repeated, and the process loops back to process 722. However, in another example, the method 700 may loop back from process 748 to an earlier process, such as process 702, process 720, or any process between processes 702 and 720.

FIG. 8 illustrates a flowchart depicting a method 800 of generating RF signals 124a, . . . 124N that are representative of RF signals generated by simulated receive antennas 212a, . . . , 212N within the simulation environment 120, in accordance with an embodiment of the present disclosure. The method 800 is at least in part performed by the waveform generators 250a, 250b.

At 804 of method 800, for each receive antenna, a corresponding digital waveform 224 in the form of a vector is received at a corresponding channel of a waveform generator, where the vector 224 is a digital representation of the waveform received by the corresponding receive antenna 212. For example, at process 744 of method 700, the simulation module 122 outputs this vector, and generation of this vector is discussed with respect to method 700. Thus, for example, the digital vector 224a is received by channel 1 of waveform generator 250a (see FIG. 6A), where the digital vector 224a is representative of the RF signal received by the antenna 212a during a given time span. Similarly, the digital vector 224h is received by channel 4 of waveform generator 250b (see FIG. 6A), where the digital vector 224h is representative of the RF signal received by the antenna 212h during a given time span.

The method 800 then proceeds from 804 to 808. At 808, for each receive antenna, the waveform generator generates a corresponding analog RF signal. For example, channel 1 of waveform generator 250a generates the RF signal 124a, based on the digital vector or signal 224a (see FIG. 6A), where the RF signal 124a is representative of a RF signal received by the antenna 212a. The method 800 then loops back from 808 to 804, e.g., as and when the platform 202 navigates (e.g., moves, yaws, pitches, and/or rolls) in accordance with the platform navigational parameters.

FIG. 9 illustrates a flowchart depicting a method 900 of estimating and tracking locations of one or more emitters, in accordance with an embodiment of the present disclosure. The method 900 is performed at least in part by the detection system 116.

At 904 of method 900, for each receive antenna, corresponding RF signal 124 is received by the detection system 116 from the waveform generators 250a, 250b. The detection system 116 also receives navigational messages 123 indicative of platform navigational path.

The method 900 then proceeds from 904 to 908. At 908, the detection system 116 estimates locations of one or more emitters, such as emitters of interest (having type SOI, see FIG. 3A), based on the received RF signals 124a, . . . , 124N and the platform navigational path. Note that the emitters are simulated emitters, locations of which are input through the UI 300a of FIG. 3A. Estimation and tracking of the locations of the emitters, by the detection system 116, are performed using appropriate emitter tracking and locations techniques. The processes 904 and 908 are repeated in loop, as and when the platform 202 navigates (e.g., moves, yaws, pitches, and/or rolls) in accordance with the platform navigational path.

Thus, in accordance with methods 700 and 800, the simulation module 122 and the waveform generators 250a, 250b continually generate the RF signals 124a, . . . , 124N, as and when the simulated platform 202 navigates (e.g., moves, yaws, pitches, and/or rolls) in accordance with the platform navigational parameters 203. The detection system 116 estimates locations of one or more of the SOI emitters 208a, . . . , 208P.

In an example, a user may choose to “play” the scenario, which effectively results in the generation of dynamic RF signals 124a, . . . , 124N over time. As the scenario is playing, the platform navigation path and/or the emitter statuses (e.g., whether detected or not, and/or “estimated” locations of the emitters) may be periodically updated on a map display, such as a map display similar to the map display of FIG. 4B. For example, FIG. 4B illustrates the current location of the platform, and the “true” or actual location of the emitter(s). In a similar figure, estimated locations of the emitters may be displayed. In yet another example, both true and estimated locations of the emitters may be displayed, so as to show the accuracy of the estimated geolocations, and how the miss distance (e.g., distance between the true and estimated emitter locations) changes over time. In an example, scenario time elapsed and/or scenario time remaining is conveyed via a progress bar in the map display. In an example, the user can optionally pause the scenario, which effectively results in the platform hovering at the current location, while the emitters continue to transmit and/or the receive antennas continue to receive RF signals, and such hovering may be used for debugging the system. In an example, the user also has the option of looping or repeating a specific scenario.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, causes one or more of the methodologies disclosed herein to be implemented. Other componentry and functionality not reflected in the illustrations will be apparent in light of this disclosure, and it will be appreciated that other embodiments are not limited to any particular hardware or software configuration. Thus, in other embodiments platform may comprise additional, fewer, or alternative subcomponents as compared to those included in the example embodiment of FIG. 2.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The aforementioned non-transitory computer readable medium may be any suitable medium for storing digital information, such as a hard drive, a server, a flash memory, and/or random access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). In some embodiments, the hardware may be modeled or developed using hardware description languages such as, for example Verilog or VHDL. Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, are functional structures that include hardware, or a combination of hardware and software, and may comprise, for example, singly or in any combination, hardwired circuitry, programmable circuitry such as computer processors comprising one or more individual instruction processing cores, state machine circuitry, and/or gate level logic. The circuitry may include a processor and/or controller programmed or otherwise configured to execute one or more instructions to perform one or more operations described herein. The instructions may be embodied as, for example, an application, software, firmware, or one or more embedded routines configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads or parallel processes in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), computers, and other processor-based or functional systems. Other embodiments may be implemented as software executed by a programmable device. In any such hardware cases that include executable software, the terms “circuit” or “circuitry” are intended to include a combination of software and hardware such as a programmable device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1. A method to simulate radio frequency (RF) signals generated by one or more simulated antennas of a simulated platform, the method comprising: receiving emitter parameters of a plurality of simulated emitters, the emitter parameters including a geolocation for at least one of the plurality of simulated emitters; receiving navigational parameters of the simulated platform, the navigational parameters indicative of a simulated navigational path of the simulated platform relative to one or more of the plurality of simulated emitters; receiving antenna parameters of a simulated antenna located on the simulated platform; and generating digital data representative of a RF signal that is estimated to be output by the simulated antenna during simulated traversal of the simulated platform along the navigational path, based on the simulated antenna receiving, in a simulated environment, signals from one or more of the plurality of simulated emitters.

Example 2. The method of example 1, further comprising: receiving, by a waveform generator, the digital data representative of the RF signal; and generating, by the waveform generator, the RF signal that is estimated to be output by the simulated antenna.

Example 3. The method of example 1, wherein the antenna parameters comprise (i) a directional gain of the simulated antenna, and/or (ii) a phase adjustment that is based on a location of the simulated antenna relative to an emitter location.

Example 4. The method of any one of examples 1-3, wherein generating the digital data representative of the RF signal comprises: generating a first waveform to be transmitted by a first simulated emitter of the plurality of simulated emitters, and a second waveform to be transmitted by a second simulated emitter of the plurality of simulated emitters; scaling and delaying the first waveform, based on an estimated distance between the first simulated emitter and the simulated antenna; and scaling and delaying the second waveform, based on an estimated distance between the second simulated emitter and the simulated antenna.

Example 5. The method of example 4, wherein generating the digital data representative of the RF signal further comprises: subsequent to scaling and delaying the first and second waveforms, applying the antenna parameters associated with the simulated antenna to the first and second waveforms, wherein the antenna parameters comprise a directional gain of the simulated antenna.

### Example 5a. The method of example 5, wherein the antenna parameters comprise a phase

adjustment that is based on a location of an antenna with the antenna array relative to an emitter location.

Example 6. The method of example 5, wherein generating the digital data representative of the RF signal further comprises: subsequent to applying the antenna parameters to the first and second waveforms, summing the first and second waveforms to generate a summed waveform, wherein the summed waveform is representative of the RF signal estimated to be received by the simulated antenna from the first and second simulated emitters.

Example 7. The method of example 6, wherein generating the digital data representative of the RF signal further comprises: quantizing the summed waveform, to generate the digital data representative of the RF signal.

Example 8. The method of any one of examples 4-7, wherein the first waveform has a first RF frequency, and the second waveform has a second RF frequency that differs from the first RF frequency by at least 500 megahertz (MHz).

Example 9. The method of any one of examples 1-8, wherein generating the digital data representative of the RF signal comprises: estimating a first waveform received by the simulated antenna from a first simulated emitter; estimating a second waveform received by the simulated antenna from a second simulated emitter; summing the first and second waveforms to provide summed waveform; generating the digital data representative of the RF signal, based on the summed waveform; and transmitting the digital data to a waveform generator, to facilitate generation of the RF signal from the digital data at the waveform generator.

Example 10. The method of any one of examples 1-9, further comprising: causing display of a graph representative of a relationship between two parameters selected from any of the emitter parameters, navigational parameters, or antenna parameters.

Example 11. The method of any one of examples 1-10, further comprising: transmitting the digital data to a waveform generator, to facilitate generation by the waveform generator of the RF signal from the digital data and transmission of the RF signal to a detection system; and transmitting the navigational parameters to the detection system.

Example 12. The method of example 11, further comprising: estimating, by the detection system, location of one or more simulated emitters, based at least in part of the RF signal received from the waveform generator and the navigational parameters.

Example 13. A computer program product including one or more non-transitory machine-readable mediums encoded with instructions that when executed by one or more processors cause a process to be carried out for simulating radio frequency (RF) signals generated by one or more simulated antennas of a simulated platform, the process comprising: estimating a first waveform received by a simulated antenna on the simulated platform from a first simulated emitter, and estimating a second waveform received by the simulated antenna from a second simulated emitter, while the simulated platform navigates relative to the first and second simulated emitters; generating digital data representative of an RF signal output by the simulated antenna, based on receiving the first waveform and the second waveform; and transmitting the digital data to a waveform generator, to facilitate generation, by the waveform generator, of RF signal from the digital data.

Example 14. The computer program product of example 13, wherein generating digital data representative of the RF signal comprises: summing the first waveform and the second waveform to generate a summed waveform; and quantizing the summed waveform to generate the digital data representative of the RF signal.

Example 15. The computer program product of any one of examples 13-14, wherein estimating the first waveform received by the simulated antenna from the first simulated emitter comprises: generating a third waveform transmitted by the first simulated emitter; scaling an amplitude and delaying the third waveform, to account for a free space path loss and delay due to a distance between the first simulated emitter and the simulated platform; and subsequent to scaling the amplitude and adjusting the phase of the third waveform, applying antenna parameters associated with the simulated antenna to the third waveform, to generate the first waveform received by the simulated antenna from the first simulated emitter, wherein antenna parameters include a gain of the antenna.

Example 15a. The computer program product of example 15, wherein the antenna parameters include a phase adjustment parameter based on a location of the simulated antenna within the array of antennas.

Example 16. The computer program product of any one of examples 13-15, wherein the process further comprises: receiving emitter parameters of a plurality of simulated emitters that includes the first and second simulated emitters, the emitter parameters including at least geolocations of one or more of the plurality of simulated emitters; receiving navigational parameters of the simulated platform, the navigational parameters indicative of at least a simulated navigational path of the simulated platform relative to one or more of the plurality of simulated emitters; and receiving antenna parameters of the simulated antenna located on the simulated platform.

Example 17. The computer program product of any one of examples 13-16, wherein the process further comprises: repeating said estimating of first waveform and the second waveform, said generating of the digital data, and said transmitting of the digital data to the waveform generator, as and when the simulated platform navigates relative to the first and second simulated emitters.

Example 18. The computer program product of any one of examples 13-17, wherein the digital data is first digital data, the simulated antenna is a first simulated antenna, and wherein the process further comprises: generating second digital data representative of another RF signal output by a second simulated antenna, based on receiving the first waveform and the second waveform from the first and second simulated emitters, respectively; and transmitting the second digital data to the waveform generator, to facilitate generation of the other RF signal from the second digital data at the waveform generator.

Example 19. A system for simulating radio frequency (RF) signals generated by one or more simulated antennas of a simulated platform, comprising: one or more memories; one or more processors; and a simulation module stored in the one or more memories and executable by the one or more processors to estimate a first waveform received by a simulated antenna on the simulated platform from a first simulated emitter, and a second waveform received by the simulated antenna from a second simulated emitter, while the simulated platform navigates relative to the first and second simulated emitters; generate digital data representative of an RF signal output by the simulated antenna, based on the simulated antenna receiving the first waveform and the second waveform; and transmit the digital data to a waveform generator.

Example 20. The system of example 19, further comprising: a waveform generator configured to receive the digital data, and generate RF signal representative of an output RF signal of the simulated antenna; and a detection system configured to receive the RF signal, and estimate a location of the first and second simulated emitters, based at least in part on the RF signal.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A method to simulate radio frequency (RF) signals generated by one or more simulated antennas of a simulated platform, the method comprising:
receiving emitter parameters of a plurality of simulated emitters, the emitter parameters including a geolocation for at least one of the plurality of simulated emitters;
receiving navigational parameters of the simulated platform, the navigational parameters indicative of a simulated navigational path of the simulated platform relative to one or more of the plurality of simulated emitters;
receiving antenna parameters of a simulated antenna located on the simulated platform; and
generating digital data representative of a RF signal that is estimated to be output by the simulated antenna during simulated traversal of the simulated platform along the navigational path, based on the simulated antenna receiving, in a simulated environment, signals from one or more of the plurality of simulated emitters.

2. The method of claim 1, further comprising:
receiving, by a waveform generator, the digital data representative of the RF signal; and
generating, by the waveform generator, the RF signal that is estimated to be output by the simulated antenna.

3. The method of claim 1, wherein generating the digital data representative of the RF signal comprises:
generating a first waveform to be transmitted by a first simulated emitter of the plurality of simulated emitters, and a second waveform to be transmitted by a second simulated emitter of the plurality of simulated emitters;
scaling and delaying the first waveform, based on an estimated distance between the first simulated emitter and the simulated antenna; and
scaling and delaying the second waveform, based on an estimated distance between the second simulated emitter and the simulated antenna.

4. The method of claim 3, wherein generating the digital data representative of the RF signal further comprises:
subsequent to scaling and delaying the first and second waveforms, applying the antenna parameters associated with the simulated antenna to the first and second waveforms, wherein the antenna parameters comprise (i) a directional gain of the simulated antenna, and/or (ii) a phase adjustment that is based on a location of the simulated antenna relative to an emitter location.

5. The method of claim 4, wherein generating the digital data representative of the RF signal further comprises:
subsequent to applying the antenna parameters to the first and second waveforms, summing the first and second waveforms to generate a summed waveform, wherein the summed waveform is representative of the RF signal estimated to be received by the simulated antenna from the first and second simulated emitters.

6. The method of claim 5, wherein generating the digital data representative of the RF signal further comprises:
quantizing the summed waveform, to generate the digital data representative of the RF signal.

7. The method of claim 3, wherein the first waveform has a first RF frequency, and the second waveform has a second RF frequency that differs from the first RF frequency by at least 500 megahertz (MHz).

8. The method of claim 1, wherein the antenna parameters comprise (i) a directional gain of the simulated antenna, and/or (ii) a phase adjustment that is based on a location of the simulated antenna relative to an emitter location.

9. The method of claim 1, wherein generating the digital data representative of the RF signal comprises:
estimating a first waveform received by the simulated antenna from a first simulated emitter;
estimating a second waveform received by the simulated antenna from a second simulated emitter;
summing the first and second waveforms to provide summed waveform;
generating the digital data representative of the RF signal, based on the summed waveform; and
transmitting the digital data to a waveform generator, to facilitate generation of the RF signal from the digital data at the waveform generator.

10. The method of claim 1, further comprising:
causing display of a graph representative of a relationship between two parameters selected from any of the emitter parameters, navigational parameters, or antenna parameters.

11. The method of claim 1, further comprising:
transmitting the digital data to a waveform generator, to facilitate generation by the waveform generator of the RF signal from the digital data and transmission of the RF signal to a detection system; and
transmitting the navigational parameters to the detection system.

12. The method of claim 11, further comprising:
estimating, by the detection system, location of one or more simulated emitters, based at least in part of the RF signal received from the waveform generator and the navigational parameters.

13. A computer program product including one or more non-transitory machine-readable mediums encoded with instructions that when executed by one or more processors cause a process to be carried out for simulating radio frequency (RF) signals generated by one or more simulated antennas of a simulated platform, the process comprising:
estimating a first waveform received by a simulated antenna on the simulated platform from a first simulated emitter, and estimating a second waveform received by the simulated antenna from a second simulated emitter, while the simulated platform navigates relative to the first and second simulated emitters;
generating digital data representative of an RF signal output by the simulated antenna, based on receiving the first waveform and the second waveform; and
transmitting the digital data to a waveform generator, to facilitate generation, by the waveform generator, of RF signal from the digital data.

14. The computer program product of claim 13, wherein generating digital data representative of the RF signal comprises:
summing the first waveform and the second waveform to generate a summed waveform; and
quantizing the summed waveform to generate the digital data representative of the RF signal.

15. The computer program product of claim 13, wherein estimating the first waveform received by the simulated antenna from the first simulated emitter comprises:
generating a third waveform transmitted by the first simulated emitter;
scaling an amplitude and delaying the third waveform, to account for a free space path loss and delay due to a distance between the first simulated emitter and the simulated platform; and
subsequent to scaling the amplitude and adjusting the phase of the third waveform, applying antenna parameters associated with the simulated antenna to the third waveform, to generate the first waveform received by the simulated antenna from the first simulated emitter, wherein antenna parameters include (i) a gain of the antenna, and/or (ii) a phase adjustment based on a location of the antenna within an array of antennas.

16. The computer program product of claim 13, wherein the process further comprises:
receiving emitter parameters of a plurality of simulated emitters that includes the first and second simulated emitters, the emitter parameters including at least geolocations of one or more of the plurality of simulated emitters;
receiving navigational parameters of the simulated platform, the navigational parameters indicative of at least a simulated navigational path of the simulated platform relative to one or more of the plurality of simulated emitters; and
receiving antenna parameters of the simulated antenna located on the simulated platform.

17. The computer program product of claim 13, wherein the process further comprises:
repeating said estimating of first waveform and the second waveform, said generating of the digital data, and said transmitting of the digital data to the waveform generator, as and when the simulated platform navigates relative to the first and second simulated emitters.

18. The computer program product of claim 13, wherein the digital data is first digital data, the simulated antenna is a first simulated antenna, and wherein the process further comprises:
generating second digital data representative of another RF signal output by a second simulated antenna, based on receiving the first waveform and the second waveform from the first and second simulated emitters, respectively; and
transmitting the second digital data to the waveform generator, to facilitate generation of the other RF signal from the second digital data at the waveform generator.

19. A system for simulating radio frequency (RF) signals generated by one or more simulated antennas of a simulated platform, comprising:
one or more memories;
one or more processors; and
a simulation module stored in the one or more memories and executable by the one or more processors to
estimate a first waveform received by a simulated antenna on the simulated platform from a first simulated emitter, and a second waveform received by the simulated antenna from a second simulated emitter, while the simulated platform navigates relative to the first and second simulated emitters;
generate digital data representative of an RF signal output by the simulated antenna, based on the simulated antenna receiving the first waveform and the second waveform; and
transmit the digital data to a waveform generator.

20. The system of claim 19, further comprising:
a waveform generator configured to receive the digital data, and generate RF signal representative of an output RF signal of the simulated antenna; and
a detection system configured to receive the RF signal, and estimate a location of the first and second simulated emitters, based at least in part on the RF signal.
